(19) United States
(12) Patent Application Publication
(10) Pub. No.: US 2005/0207115 A1
(43) Pub. Date: Sep. 22, 2005

(54) Heat dissipating arrangement

(75) Inventors: Stephan K. Barsun, Davis, CA (US); Christian L. Belady, McKinney, TX (US); Roy M. Zeighami, McKinney, TX (US); Christopher G. Malone, Loomis, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/803,399

(22) Filed: Mar. 18, 2004

(51) Int. Cl. G06F 1/20

(52) U.S. Cl. 361/690

(57) ABSTRACT

A heat dissipating arrangement includes a first heat emitting device, a second heat emitting device, and a heat sink thermally coupled to the first heat emitting device and extending on opposite sides of the second heat emitting device.

### BACKGROUND

Computing systems typically include numerous electronic devices that generate large amounts of heat. Unless the generated heat is adequately expelled or dissipated from the device, the device may overheat and become damaged. Examples of heat-generating electronic devices include processors and power supplies or power pods.

To cool or dissipate heat from processors and power pods, many computer systems include heat sinks positioned adjacent the processor and the power pod. Such heat sinks are generally thermally conductive and have a large surface area for dissipating heat from the processor or from the power pod.

In many computer systems, adequate cooling of the processor is difficult to achieve. Achieving adequate cooling of the processor is even more problematic in those systems where multiple electronic components, such as processors and dedicated power pods are crowded next to one another within the system. For example, in many computer systems, multiple processors are placed in series so that the processors and their respective heat sinks pre-heat the air flowing to the next processor and heat sink. In an attempt to increase cooling of the processor, some computer systems utilize the common heat sink base for both the processor and the power pod. Although the common base increases cooling of the processor, it requires the usage of a different heat sink for each different implementation, increasing supply chain costs. In addition, because power pods generate much less heat as compared to the processor, this attempted solution often results in the processor actually heating the power pod. In another attempt to increase cooling of the processor, some computer systems utilize active heat sinks or turbo coolers which are equipped with fans. This solution increases the cost and reduces the reliability of the system.

### SUMMARY OF THE INVENTION

A computing system includes a circuit board, a first device having a first heat transfer surface, a second device coupled to the circuit board and having a second heat transfer surface, a first heat sink and a second heat sink. The first heat sink includes a first base thermally coupled to a first heat transfer surface and a first array of fins thermally coupled to the first base. The second heat sink includes a second base thermally coupled to the second heat transfer surface and a second array of fins coupled to the second base. The second array of fins extend at least partially across the first array of fins.

### BRIEF DESCRIPTION OF THE DRAWINGS

FIG. 1 is a schematic illustration of one embodiment of a computing system of the present invention.

FIG. 2 is a top perspective view of a portion of one embodiment of the computing system of FIG. 1 with portions omitted for purposes of illustration.

FIG. 3 is a side elevational view of a multi-device heat sink module of the computing system of FIG. 2.

FIG. 4 is a top plan view of the module of FIG. 3.

FIG. 5 is a sectional view of the module of FIG. 4 taken along line 5--5.

### DETAILED DESCRIPTION OF THE EXAMPLE EMBODIMENTS

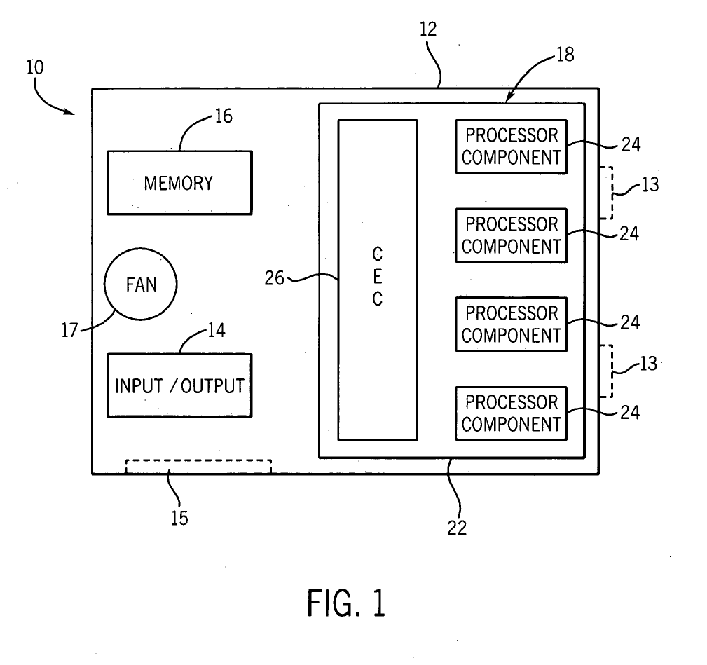

FIG. 1 schematically illustrates computing system 10. Computing system 10 (shown as a server) generally includes baseboard 12, input/output 14, memory 16, cooling fan 17 and processor system 18. Baseboard 12 connects input/output 14, memory 16 and processor system 18. Baseboard 12 comprises a circuit board and serves as an electronic highway between the remaining electronic components of system 10. Although computing system 10 is generally illustrated as a planar system, baseboard 12 may additionally include connectors 13 (shown with broken lines) for enabling baseboard 12 to be connected to a backplane such as when computing system 10 comprises a multi-board system.

Input/output 14 generally comprises an input/output board coupled to baseboard 204. The input/output board supports a plurality of input/output cards. Input/output 14 facilitates the use of additional peripherals such as tape drives, DVDs, and the like with computing system 10. In alternative embodiments, computing system 10 may additionally or alternatively include input/output connectors 15 (illustrated with broken lines) for connection to external input/output boards or cards.

Memory 16 is coupled to baseboard 12 and provides additional memory storage for computing system 10. For purposes of this disclosure, the term “coupled” means the joining of two or more members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. In the particular embodiment shown, memory 16 comprises two memory extenders or circuit boards carrying a plurality of memory cards.

Cooling fan or fans 17 comprises one or more fans provided within computing system 10 and configured to direct air through system 10 so as to cool and dissipate heat away from the internal components of system 10. Although cooling fan 17 is schematically illustrated between input/output 14 and memory 16, cooling fan 17 may be located in a variety of locations within system 10. For example, cooling fan 17 may be positioned proximate to processor system 18 to cool the electronic devices of processor system 18. In alternative embodiments, cooling fan 17 may comprise one or more fans remote to baseboard 12, wherein cooling fan 17 is sized and located to cool the entire computing system.

Processor system 18 does much of the computing or calculations for computing system 10 and generally includes a processor board or circuit board 22, a plurality of processor components 24 and a control or controls 26 (known as a computer electronic control or CEC). Circuit board 22 comprises a conventionally known or future developed circuit board (also known as a printed circuit assembly) capable of serving as an interface between the various elements connected to circuit board 22. Circuit board 22 is coupled to baseboard 12 and electronically connects each of processor components 24 to control 26. In one embodiment, two processor components 24 extend on a first side of circuit board 22, and two processor components 24 extend on an opposite side of circuit board 22. In the schematic depiction, circuit board 22 may extend either parallel or perpendicular to baseboard 12. In alternative embodiments, the functions of baseboard 12 and circuit board 22 may be provided by a single circuit board, enabling one of baseboard 12 and circuit board 22 to be eliminated. For example, input/output 14, memory 16, fan 17, processor components 24 and controller 26 may alternatively electronically connected to a single circuit board.

Control 26 serves as a traffic cop between each of the processor components 24, memory 16 and input/output 14. In alternative embodiments, processor components 24, memory 16 and input/output 14 may directly communicate with one another. Although not shown, computer system may additionally include a power supply for supplying power to devices other than components 24 and a housing for enclosing and supporting each of the components. Overall, input/output 14, memory 16 and processor system 18 cooperate with one another to provide information retrieval and processing.

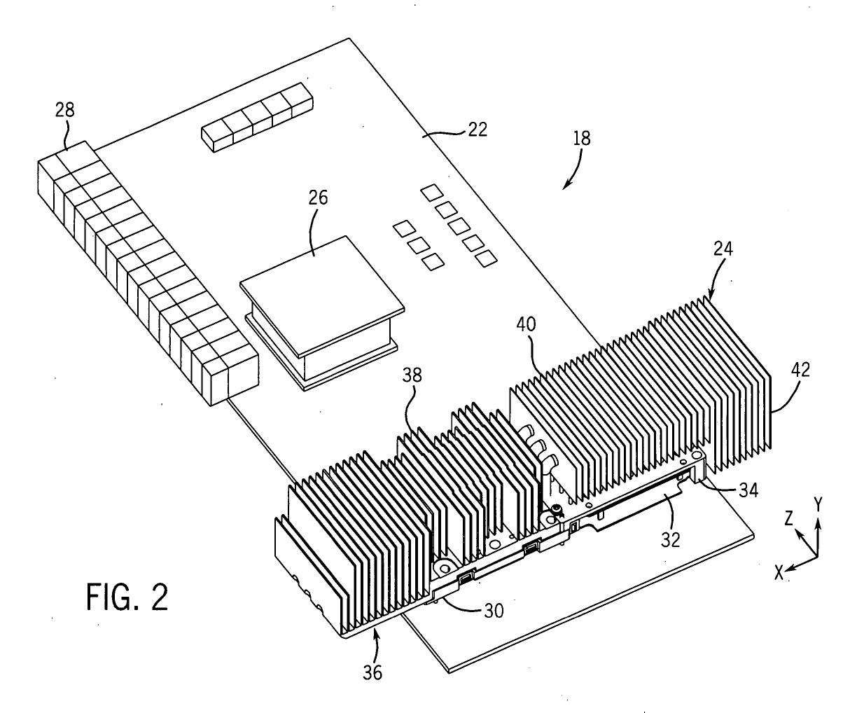

FIG. 2 is a top perspective view illustrating processor system 18 in greater detail. For ease of illustration, processor system 18 is shown as including only a single component 24. In addition, processor system 18 is illustrated as omitting a support frame which extends about board 22 to rigidify board 22. As shown by FIG. 2, processor system 18 additionally includes connector 28 electrically connected to circuit board 22 and configured to be connected to a corresponding connector portion electronically connected to baseboard 12 (shown in FIG. 1).

Processor component 24 generally comprises a multi-device heat sink module electronically and mechanically connected to circuit board 22. Component 24 includes heat-generating electronic device 30, electronic device 32, heat sink 34 and heat sink 36. Device 30 is electrically connected to circuit board 22 and generates heat during its operation. In the particular embodiment illustrated, device 30 comprises a processor assembly (sometimes referred to as a central processing unit or CPU).

Device 32 is electronically connected to device 30 so as to cooperate with device 30. In the particular embodiment illustrated, device 32 is also physically connected to device 30 such that devices 30 and 32 form a unit or module that is movable as a single body. In alternative embodiments, devices 30 and 32 may be coupled to circuit board 22 independent of one another, wherein heat sink 36 extends over heat sink 34. In the particular embodiment illustrated, device 32 comprises a power pod configured to supply electrical power to device 30. In the embodiment shown in which device 32 comprises a power pod, device 32 itself generates heat during its operation. The amount of heat generated by device 32 is less than the amount of heat generated by device 30 during their normal operation.

Heat sink 34 extends adjacent to device 32 and is configured to dissipate heat generated by device 32. Heat sink 36 extends adjacent to device 30 and is configured to dissipate heat generated by device 30. As shown by FIG. 2, heat sink 36 includes a first portion 38 extending over and adjacent to device 30, a second portion 40 extending over device 32 and over heat sink 34 and a third portion 42 extending beyond heat sink 34 such that portion 38 and 42 extend beyond opposite sides of heat sink 34. In the particular embodiment illustrated, portion 42 additionally extends from above heat sink 34 towards circuit board 22 so as to extend around or wrap about a portion of heat sink 34. As a result, heat sink 34 is partially nested within heat sink 36. Because heat sink 36 extends over, across and outwardly beyond heat sink 34, heat sink 36 has a larger size and a greater surface area for more effectively dissipating heat generated by device 30. Because heat sink 36 extends partially about heat sink 34 such that heat sink 34 is nested within heat sink 36, heat sink 36 has an even greater surface area for improved cooling of device 30. At the same time, heat sink 36 efficiently utilizes the volume or space above and to the side of heat sink 34 and device 32 without requiring or occupying additional space along circuit board 22. This enables a larger number of modules to be positioned along circuit board 22 and enables computing system 10 to be smaller and more compact. In alternative embodiments, portion 42 of heat sink 36 may be omitted.

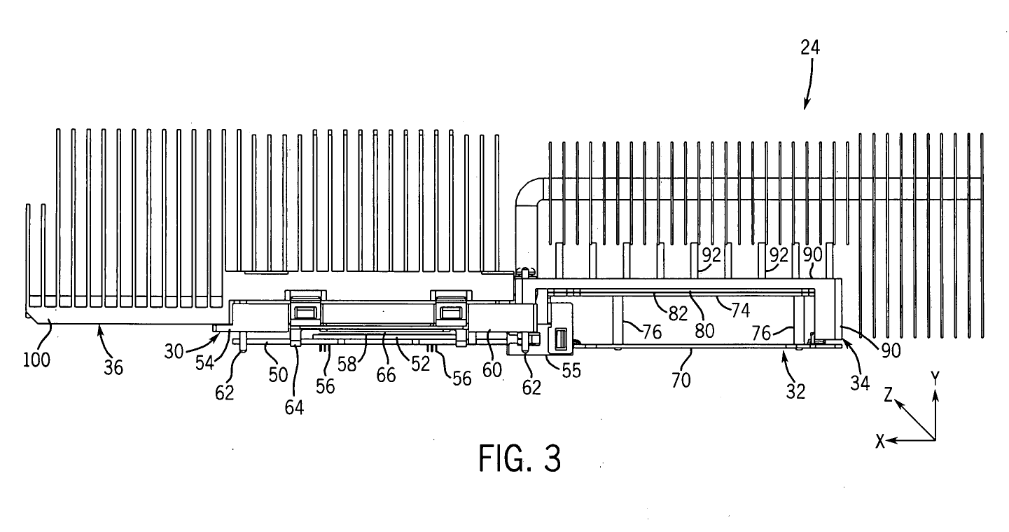

FIGS. 3-5 illustrate component 24 in greater detail. As best shown by FIG. 3, device 30 (shown as a processor assembly) generally includes substrate 50, processor chip 52, and carrier assembly 54. Substrate 50 comprises a circuit board configured to be electrically connected to circuit board 22 (shown in FIG. 2). Substrate 50 includes connector pins 56.

Processor chip 52 comprises an integrated circuit chip which performs calculations and logic. Processor chip 52 is mounted to substrate 50 and has a heat transfer surface 58 by which heat generated by processor chip 52 is conducted away from chip 52. In particular embodiments, a heat spreader may extend proximate to the heat transfer surface 58 of chip 52. Such a heat spreader may comprise a highly conductive member formed from such materials as aluminum or copper, wherein the spreader spreads heat from surface 58 across an even larger surface.

Carrier assembly 54 comprises one or more structures configured to support the mass of component 24 above circuit board 22 and to physically couple substrate 50 and processor chip 52 to heat sink 36. In the particular embodiment illustrated, carrier assembly 54 is further coupled to heat sink 34. Because heat sink 34 supports device 32 (shown as a power pod), devices 30, 32 and heat sink 34, are joined to form a single platform 37. Heat sink 36 is coupled to platform 37 to form a single unit or module. Because heat sink 36 is added to platform 37, heat sink 36 may be modified or tailored for use with differently configured platforms 37.

In the particular embodiment illustrated, carrier assembly 54 includes carrier 60, stand-offs 62, substrate support 64 and thermal interface 66. Carrier 60 serves as a base structure which is coupled to heat sink 34 and heat sink 36. Stand-offs 62 extend from carrier 60 and are configured to be connected directly to circuit board 22 or a frame (not shown) adjacent to circuit board 22. Substrate support 64 generally comprises a structure, such as a bracket or frame, mounted to carrier 60 and extending around substrate 50 so as to suspend substrate 50 relative to carrier 60.

Thermal interface 66 comprises one or more structures extending between heat transfer surface 58 and processor chip 52 and heat sink 36. In the embodiment illustrated, interface 66 includes a lid and a seal. In particular embodiments, highly thermally conductive adhesives and thermally conductive materials are provided between surface 58 and interface 66 and/or interface 66 and heat sink 36. In alternative embodiments, interface 66 may be omitted. In some embodiments, highly thermally conductive adhesive or other thermally conductive material, such as thermal grease, may be positioned directly between heat transfer surface 58 and heat sink 36.

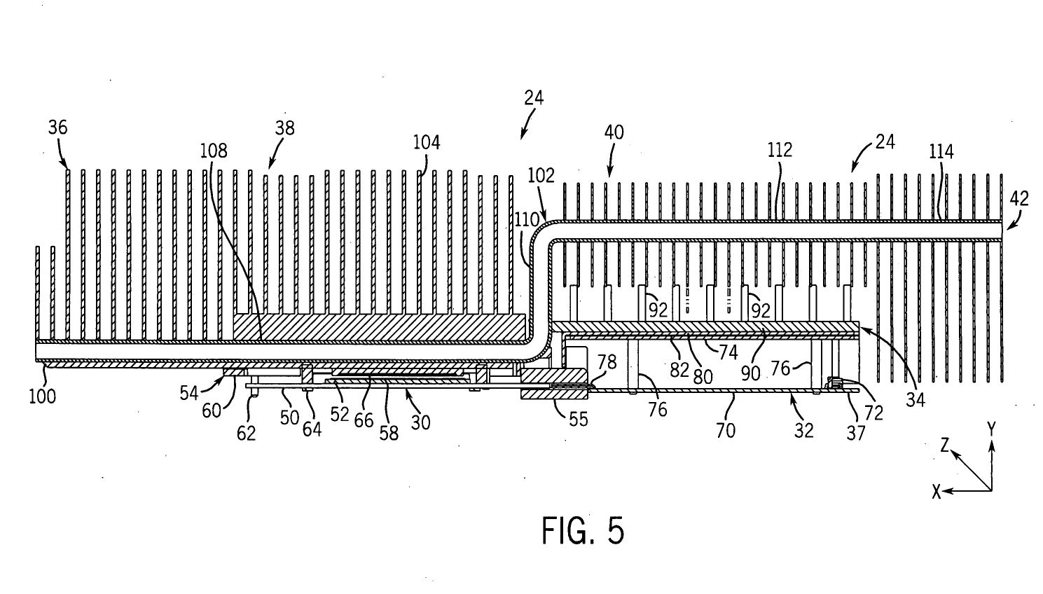

Connector 55 electrically interconnects device 30 to device 32. As best shown by FIG. 5, connector 55 is electrically mounted to substrate 50 which is electrically connected to device 32. In alternative embodiments, device 30 may be electrically connected to device 32 by cabling or other forms of connectors.

As best shown by FIGS. 3 and 5, device 32 (shown as a power pod) generally includes control board 70, power input connector 72, power printed circuit board 74, bus bar 76, connector 78 and thermal interface 80. Control board 70 comprises a printed circuit board onto which power input connector 72 and connector 78 are electrically connected. Power input connector 72 generally comprises a connector for facilitating connection of device 32 to a power source. Control board 70 is electrically connected to power circuit board 74 via bus bars 76. Control board 70 and power circuit board 74 include one or more integral electrical components for transforming and providing electrical power to device 32 as needed in a known manner. Power circuit board 74 includes heat transfer surface 82 thermally coupled to heat sink 34. Connector 78 electrically connects device 32 to device 30 via connector 55. In the particular embodiment illustrated, connector 78 comprises a flexible cable. In alternative embodiments, connector 78 may comprise a pin or a socket connector or other forms of connectors.

Thermal interface 80 thermally couples heat transfer surface 82 to heat sink 34. For purposes of this disclosure, the term “thermally coupled” means two elements are positioned relative to one another such that heat is transferred between such elements. Such elements may be in direct contact with one another, spaced from one another but sufficiently close such that heat is transferred through gas or air between such elements, or may be positioned with intermediate structures or materials that have relatively high thermal conductivities such as thermally conductive epoxies, paste or thermally conductive metals such as aluminum, aluminum alloys, copper or copper alloys. For purposes of the disclosure, the use of the term “coupled” by itself will specifically refer to physical coupling rather than thermal coupling.

In the illustrated embodiment, interface 80 comprises a thermally conductive lid in thermal contact with transfer surface 82 and heat sink 34. In alternative embodiments, additional highly thermally conductive adhesives or materials may be provided between surface 82 and interface 80 or between interface 80 and heat sink 34. For example, a thermally conductive adhesive or other thermally conductive material may be provided between heat transfer surface 82 and interface 80 and/or between interface 80 and heat sink 34. In the particular embodiment, interface 80 additionally functions as a framework for supporting the remaining components of device 32 adjacent to heat sink 34. In alternative embodiments, interface 80 may be omitted where heat transfer surface 82 is in direct thermal contact with heat sink 34 or other thermally conductive materials, either rigid or fluid like, are positioned between heat transfer surface 82 and heat sink 34.

FIGS. 3 and 5 merely illustrate examples of devices 30 and 32. In alternative embodiments, device 30 may comprise other forms of processor assemblies having different components or different structural relationships, wherein device 30 generates heat and has a heat transfer surface generally coupled to heat sink 36. Likewise, in alternative embodiments, device 32 may comprise other forms of power pods having different components or having different structural relationships. In still other embodiments, devices 30 and 32 may comprise other devices utilized in a computing, system which perform functions other than processor assembly and power pod shown, but which require the dissipation of heat in at least one of the devices.

Heat sink 34 generally comprises a structure configured to thermally conduct and dissipate heat away from heat transfer surface 82 of device 32. Heat sink 34 includes base 90 and an array of thermally conductive fins 92. Base 90 comprises a structure formed from highly thermally conductive material thermally coupled to heat transfer surface 82 of device 32. In the particular embodiment illustrated, base 34 is formed from a thermally conductive metal such as aluminum, aluminum alloys, copper or copper alloys. In particular embodiments, base 34 may be formed from multiple thermally conductive metals and may have various shapes and structures other than the shapes shown. Base 90 is mounted to carrier 60 of carrier assembly 54 and supports fins 92.

Fins 92 generally comprise extensions, columns, posts, wings or plates of highly thermally conductive material or materials coupled to and extending from base 90. Fins 92 extend from base 90 in a direction away from circuit board 22 (shown in FIG. 2) when component 24 is coupled to circuit board 22. Wings 92 provide an enlarged surface area for dissipating heat conducted from heat transfer surface 82 to interface 80 through base 90. In alternative embodiments, heat sink 34 may omit fins 92.

Heat sink 36 is thermally coupled to heat transfer surface 58 of processor chip 52 to permit heat generated by processor chip 52 to be transferred to heat sink 36 for dissipation. As best shown by FIG. 5, heat sink 36 generally includes base 100, heat pipes 102 and an array of fins 104. Base 100 includes one or more structures formed from materials that are highly thermally conductive such as aluminum or aluminum alloys or copper or copper alloys. Base 100 is thermally coupled to heat transfer surface 58 by interface 66 and by one or more highly thermally conductive materials such as adhesives or paste-like compositions which may or may not harden or solidify. Base 100 is coupled to heat pipes 102 and fins 104 to assist in supporting such elements.

Heat pipes 102 comprise high thermal conductivity tubes configured to facilitate the transfer of heat from a warmer region to a cooler region. In one embodiment, heat pipes 102 may comprise vapor chamber plate heat pipes. Alternatively, various other conventionally known or future developed heat pipes may be employed. Heat pipes 102 are thermally coupled to base 100 and extend at least partially across heat transfer surface 58 of device 30 and also across device 32 and heat sink 34. As shown by FIG. 5, heat pipes 102 include a first portion 108 extending across heat transfer surface 58 generally below heat sink 34, a second portion 110 extending from portion 108 from below heat sink 34 to above heat sink 34, a third portion 112 extending over and across heat sink 34 and a fourth portion 114 extending outwardly beyond heat sink 34. Portion 108 extends in close proximity to heat transfer surface 58 to facilitate improved transfer of heat from device 30. Portions 110, 112 and 114 rise above and extend over and beyond heat sink 34 to enlarge the amount of surface area of heat sink 36. In particular, portion 112 of heat pipes 102 supports portions 40 and 42 of heat sink 36 above device 32 and heat sink 34. In alternative embodiments, additional structures could be used to support heat sink 36 and fins 104. For purposes of the disclosure, the terms “above” and “below” are used only to describe the relative positioning of structures as shown in FIGS. 3 and 5. In other embodiments, component 24 may be coupled to circuit board 22 in orientations other than that shown in FIG. 5, such as sideways or upside down, which would result in those elements of component 24 having different relative positions. For example, if component 24 was mounted on an underside of circuit board 22 (shown in FIG. 2), portion 112 of heat pipe 102 would extend below heat sink 34.

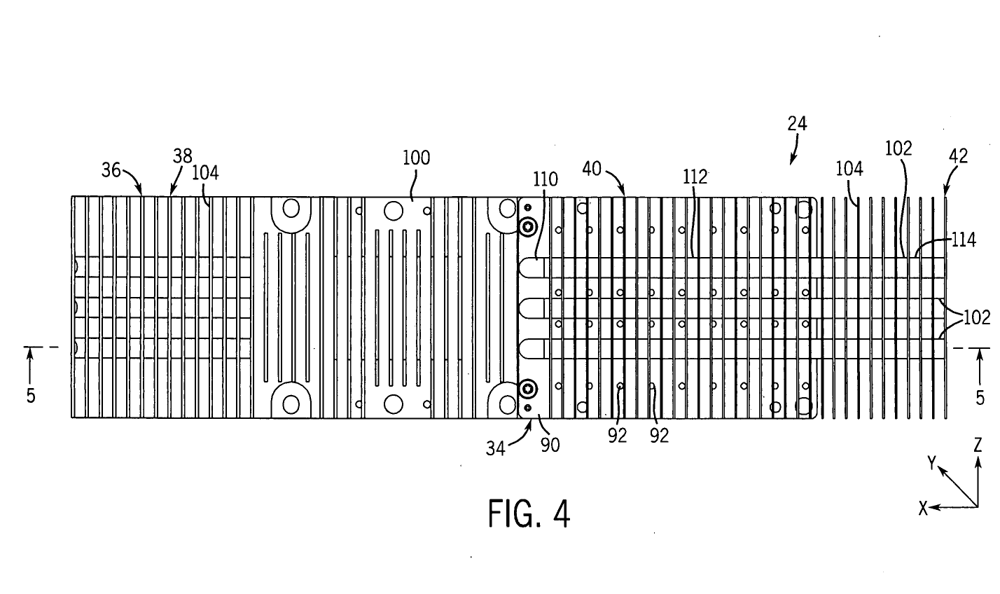

Because heat pipes 102 support portions 40 and 42 of heat sink 36, heat sink 36 may be formed as a single unitary complete structure which may then be later assembled to device 30, device 32 and heat sink 34. In alternative embodiments, at least portions 112 and 114 of heat pipes 102 may be mounted and supported by heat sink 34 wherein such portions are generally coupled to portion 108 and portion 110. In still other embodiments, base 100 may alternatively be configured so as to extend over and beyond heat sink 34 while supporting heat pipes 102 and fins 104. In such embodiments where base 100 extends over and above heat sink 34, heat pipes 102 may be omitted. Although heat sink 36 is illustrated in FIG. 4 as including three heat pipes 102, heat sink 36 may alternatively include a greater or fewer number of such heat pipes.

Fins 104 comprise columns, posts, panels, plates or other shaped extensions formed from one or more materials that are highly thermally conductive such as aluminum, aluminum alloys, copper or copper alloys. As best shown by FIG. 5, fins 104 of portion 38 of heat sink 36 extend from base 100 in a positive Y-axis direction away from device 30. Fins 104 of portion 40 of heat sink 36 extend about portion 112 of heat pipes 102 above at least portions of heat sink 34. In particular, fins 104 of portion 40 extend above fins 92 of heat sink 34. In other words, the tips of fins 92 terminate generally above or at a location in close proximity to tips of fins 92. Alternatively, as shown in phantom, one or more of fins 104 of portion 112 may be configured so as to extend between consecutive fins 92 such that fins 104 are interleaved between fins 92 for providing even greater surface area for dissipating heat while not requiring the consumption of additional space along circuit board 22 or within the computing system.

Fins 104 of portion 42 of heat sink 36 extend from and about portion 114 of heat pipes 102. Fins 104 of portion 40 additionally extend from above heat sink 34, towards circuit board 22 (shown in FIG. 2) and below heat sink 34. As a result, heat sink 34 is nested within heat sink 36 along the X axis and fins 104 of heat sink 36 extend on opposite sides of heat sink 34 as a whole. Fins 104 also extend from below to above heat sink 34. This enlarged surface area improves the rate at which heat sink 36 dissipates heat without requiring additional space. Although not illustrated, fins 104 of portion 40 may additionally extend outwardly in both a positive and negative Z axis direction and downwardly in the negative Y axis direction from above heat sink 34 to below a top portion of heat sink 34 such that heat sink 34 is also or alternatively nested within fins 104 of portion 40 along the Z axis.

Although fins 104 of portions 40 and 42 are illustrated as extending about portions 112 and 114 of all of heat pipes 102, heat pipes 102 may alternatively extend in a single direction from portions 112 and 114 of heat pipes 102. As noted above, in alternative embodiments, base 100 may alternatively or additionally extend above and potentially beyond heat sink 34, wherein fins 104 extend from the base in one or more directions. In other embodiments, fins 104 in one or more of portions 38, 40 or 42 may be omitted where space is unavailable or cooling requirements may be lower.

Overall, computing system 10 achieves more reliable performance due to the improved cooling of its internal devices while maintaining its space efficiency and compact nature. Because both heat sink 34 and heat sink 36 include heat dissipating fins, heat from both devices 30 and 32 is more effectively dissipated. Because heat sink 36 extends over fins 92 of heat sink 34, heat sink 36 has an even larger surface area for dissipating heat. Because heat sink 36 additionally extends outwardly beyond heat sink 34, heat dissipation by heat sink 36 is further improved. The heat dissipating surface area of heat sink 36 is even further enlarged because heat sink 36 extends at least partially around heat sink 34 such that heat sink 34 is at least partially nested within heat sink 36.

Because devices 30, 32 and heat sinks 34, 36 are assembled together as a single module, such devices may be preassembled prior to being connected to circuit board 22. Similarly, heat sink 36 is also formed as a single unit. As a result, the manufacture and assembly of computer system 10 is more efficient and less expensive. As noted above, in alternative embodiments, devices 30 and 32, and their associated heat sinks 34 and 36, respectively, may alternatively be assembled independent of one another along circuit board 22. Although heat sink 36 is illustrated as being employed with a computing system, heat sink 36 may be modified for use with other electronic devices or in other arrangements having two heat emitting devices, elements, or components that must be cooled by dissipating heat away from at least one of the devices.

Although the present invention has been described with reference to example embodiments, workers skilled in the art will recognize that changes may be made in form and detail without departing from the spirit and scope of the invention. For example, although different example embodiments may have been described as including one or more features providing one or more benefits, it is contemplated that the described features may be interchanged with one another or alternatively be combined with one another in the described example embodiments or in other alternative embodiments. Because the technology of the present invention is relatively complex, not all changes in the technology are foreseeable. The present invention described with reference to the example embodiments and set forth in the following claims is manifestly intended to be as broad as possible. For example, unless specifically otherwise noted, the claims reciting a single particular element also encompass a plurality of such particular elements.

1. A computing system comprising:
a circuit board;
a first device having a first heat transfer surface;
a first heat sink including:
a first base thermally coupled to the first heat transfer surface; and
a first array of fins thermally coupled to the first base;
a second device coupled to the circuit board, the second device having a second heat transfer surface; and
a second heat sink including:
a second base thermally coupled to the second heat transfer surface; and
a second array of fins coupled to the second base and extending at least partially across the first array of fins.

2. The system of claim 1, wherein the first device is electrically connected to the second device.

3. The system of claim 1, wherein the first device generates heat at a first rate and wherein the second device generates heat at a second greater rate.

4. The system of claim 1, wherein the second device comprises a processor assembly including a central processing unit.

5. The system of claim 4, wherein the first device comprises a power pod assembly.

6. The system of claim 5, wherein the power pod assembly is dedicated solely to supplying power to the processor assembly.

7. The system of claim 1, wherein the first device comprises a power pod assembly.

8. The system of claim 1, wherein the second array of fins extends on opposite sides of the first device.

9. The system of claim 1, wherein the second heat sink includes a heat pipe extending at least partially across the first array of fins.

10. The system of claim 9, wherein the heat pipe supports the second array of fins over the first array of fins.

11. The system of claim 9, wherein the heat pipe extends at least partially along the second base.

12. The system of claim 9, wherein the heat pipe extends from below the first base to above the first array of fins.

13. The system of claim 1, wherein the first device and the second device are coupled to one another to form a multi-device module adapted to be connected to the circuit board.

14. The system of claim 1 including:
a third device having a third heat transfer surface;
the third heat sink including:
a third base thermally coupled to the third heat sink; and
a third array of fins thermally coupled to the third base;
a fourth device coupled to the circuit board, the fourth device having a fourth heat transfer surface; and
a fourth heat sink including:
a fourth base thermally coupled to the fourth heat transfer surface; and
a fourth array of fins coupled to the fourth base and extending at least partially across the third array of fins.

15. The system of claim 14 including a central electronic control coupled to the circuit board.

16. The system of claim 14 including:
a baseboard coupled to the circuit board;
a memory device coupled to the baseboard; and
an input/output device coupled to the baseboard.

17. The system of claim 14 including a fan configured to create an air flow across the second device and across the fourth device.

18. The system of claim 1, wherein at least one of the first array of fins is interleaved with the second array of fins.

19. A multi-device heat sink module adapted to be connected to a circuit board, the module comprising:
a first device having a first heat transfer surface;
a first heat sink having a first base thermally coupled to the first heat transfer surface;
a second device coupled to the first device and having a second heat transfer surface;
a second heat sink having a second base thermally coupled to the second heat transfer surface; and
a connector connected to one of the first device and the second device and configured to be electrically connected to the circuit board, wherein at least a portion of the second heat sink extends at least partially across the first heat sink.

20. The module of claim 19, wherein the first heat sink includes a first array of fins thermally coupled to the first base.

21. The module of claim 20, wherein the second heat sink extends at least partially across the first array of fins.

22. The module of claim 21, wherein the second heat sink includes a second array of fins, wherein the second array of fins extends at least partially across the first array of fins.

23. The module of claim 22, wherein the second array of fins extends on opposite sides of the first array of fins.

24. The module of claim 22, wherein the second heat sink includes a heat pipe extending at least partially across the first array of fins.

25. The module of claim 24, wherein the heat pipe extends at least partially along the second base.

26. The module of claim 24, wherein the heat pipe extends from below the first base to above the first array of fins.

27. The module of claim 19, wherein the first device is electrically connected to the second device.

28. The module of claim 19, wherein the first device generates heat at a first rate and wherein the second device generates heat at a second greater rate.

29. The module of claim 19, wherein the second device comprises a processor assembly including a central processing unit.

30. The module of claim 29, wherein the first device comprises a power pod assembly.

31. The module of claim 30, wherein the power pod assembly is dedicated solely to supplying power to the processor assembly.

32. The module of claim 19, wherein the first device comprises a power pod assembly.

33. The module of claim 18, wherein the second heat sink includes:
a heat pipe extending above the first heat sink; and
an array of fins thermally coupled to the heat pipe and supported by the heat pipe above the first heat sink.

34. A processor module comprising:
a processor configured to be connected to a circuit board, the processor having a first heat transfer surface;
a power pod electrically connected to the processor to supply power to the processor, the power pod having a second heat transfer surface;
a first heat sink thermally coupled to the second heat transfer surface; and
a second heat sink thermally coupled to the first heat transfer surface, wherein the second heat sink extends at least partially across the first heat sink.

35. The module of claim 34, wherein the second heat sink extends completely across the first heat sink.

36. The module of claim 35, wherein the second heat sink extends on opposite sides of the first heat sink.

37. A multi-device heat sink module for being connected to a circuit board, the module comprising:
a first device emitting heat;
a second device emitting heat;
a first means for dissipating heat emitted by the first device; and
a second means for dissipating heat emitted by the second device, wherein the second means extends at least partially across the first means.

38. The module of claim 37, wherein the first device comprises a processor and wherein the second device comprises a power supply supplying the processor with power.

39. A heat dissipating arrangement comprising:
a first heat emitting device;
a second heat emitting device; and
a first heat sink thermally coupled to the first device, wherein the first heat sink extends on opposite sides of the second device.

40. The arrangement of claim 39 including a second heat sink thermally coupled to the second device, wherein the first heat sink extends on opposite sides of the second heat sink.

41. A first heat sink for use with a first heat emitting device, a second heat emitting device and a second heat sink thermally coupled to the second heat emitting device, the first heat sink comprising:
at least one heat dissipating structure configured to be thermally coupled to the first heat emitting device while extending at least partially around and on opposite sides of the second heat sink.

42. A first heat sink for use with a first heat emitting device, a second heat emitting device, and a second heat sink thermally coupled to the second heat emitting device and having a plurality of fins, the first heat sink comprising:
at least one heat dissipating structure configured to be thermally coupled to the first heat emitting device while extending at least partially across the plurality of fins of the second heat sink.

43. A method for dissipating heat from a first electronic device positioned proximate a second electronic device, the method comprising:
directing heat generated by the first device across and around at least a portion of the second device so as to dissipate heat on opposite sides of the portion of the second device.

44. The method of claim 43, wherein the second device includes a first array of heat dissipating surfaces and wherein the method further includes nesting the first device within the first array of heat dissipating surfaces.

45. The method of claim 44, wherein the second device includes a second array of heat dissipating surfaces, wherein the method includes nesting the second array of heat dissipating surfaces within the first array of heat dissipating surfaces to dissipate heat on opposite sides of the second array of heat dissipating surfaces.
